(19) United States
(12) Patent Application Publication
(10) Pub. No.: US 2007/0164118 A1
(43) Pub. Date: Jul. 19, 2007

(54) Keeping a dual-interface object in fully simultaneous operation

(75) Inventors: Laurent Degauque, Roquevaire (FR); Stephane Di-Vito, La Ciotat (FR); Thierry Garnier, Gemenos (FR); Henri Ohanian, Ceyreste (FR)

Correspondence Address: BUCHANAN, INGERSOLL & ROONEY PC, POST OFFICE BOX 1404, ALEXANDRIA, VA, 22313-1404, US

(73) Assignee: GEMPLUS, Gemenos (FR)

(21) Appl. No.: 10/583,250

(22) PCT Filed: Dec. 16, 2004
(86) PCT No.: PCT/EP04/53529

§ 371 Date: Jun. 16, 2006

(30) Foreign Application Priority Data
Dec. 17, 2003 (FR) 03/51089

(51) Int. Cl. G06K 19/06; G06K 7/06; G06K 7/08

(52) U.S. Cl. 235/492; 235/451; 235/441

(57) ABSTRACT

The invention relates to the operational maintenance of an intelligent portable object (1) which is provided with a processing unit (6) having at least two communication and/or feed interfaces either with or without contacts. The method comprises a reinitialization step (MaZ) for the processing unit (6). The method is characterized in that it comprises at least one delay and/or reinitialization simulation step if a communication or application is in the process of being processed by the processing unit. The invention also relates to an associated device.

This disclosure is based upon French Application No. 03/51089 filed Dec. 17, 2003 and International Application No. PCT/EP2004/053529, filed Dec. 16, 2004, the contents of which are incorporated herein by reference.

### BACKGROUND OF THE INVENTION

The invention relates to secure operation, inside a smart portable object, of a contactless communications interface simultaneously with operation of a contact or galvanic communications interface.

It also relates to secure operation of an application whose data passes via the contactless interface simultaneously with a distinct application whose data passes via the galvanic interface.

Sustaining full simultaneous operation of a dual-interface object is the aim here.

The invention also applies to a smart object having at least two interfaces, of the same type or of different types.

As a preamble, known techniques and their terminologies are given below.

A distinction should be made here between smart portable objects and electronic data-transmission terminals.

Smart portable objects are, for example, smart cards, electronic tickets, “dongles”, or other modules such as proximity communications modules (e.g. Near Field Communications (NFC) modules, or semi-proximity (e.g. BlueTooth) modules. Theses objects are subjected to standards that require them to comply with structure and operation constraints.

In particular, the objects concerned here preferably, but not exclusively, comply with standards given in detail further below:

ISO7816.3 relating to the galvanic communications interface, in particular Chapter 5.2 (Activation), and paragraphs 532 (cold rest (“RST”), see FIG. 2), 533, and 534 (clock pause or “CLK”; description of modes requiring that such interruption be withstood);

In examples, the object also complies with the following standards:
ISO.IEC14443 relating to the contactless switching interface, in particular Chapter 611 (Frame Delay Time (“FDT”); and
3GPPTS11.11 relating to Subscriber Identity Module (“SIM”) objects or the like, for insertion into a terminal, in particular Chapter 43 (galvanic communications interface).

It should be noted that, in examples, the contactless interface has an antenna, integrated into a module of said object; and/or integrated into a card body of the object; and/or integrated into the terminal to be made secure, and connected via a galvanic terminal block.

Thus, the smart portable objects concerned here are structurally contact and contactless objects (i.e. objects with contacts and without contacts); they are referred to as “CombiCards” or “dual-interface” objects. In other words, the objects have both:
means and steps for communicating remotely via a contactless interface with one or more electronic data-transmission terminals and/or other remote portable objects; and also
means and steps for communicating via a galvanic or contact connection via a galvanic or resistive interface referred to as the “contact interface”. It should be noted that the contactless interface is internal to the object at least in part.

It should however be emphasized that the objects in question preferably satisfy Standard ISO7816.3.

As regards the contactless communications protocols used by the object, examples are: ISOIEC14443 (RF); communications specifications such as specifications for proximity communications such as ECMA340 or “NFC”, or semi-proximity communications such as “BlueTooth” and other broadband communications referred to as “WiFi” (Wireless Fidelity) communications.

Among the current objects suitable for complying with Standards ISO7816.3 and with a “contactless” standard, mention might be made of those that have chips: Hitachi AE45 (Renesas); Infineon SLE 66CLX320P; Philips P5CT072; and STMicroElectronics ST19XR34.

Faced with the paradoxical constraints required, dual-module objects have been proposed.

In particular, a card is known that has firstly a first contact interface with its own dedicated chip, and secondly a contactless interface with a chip different from the contact chip, which different chip is also dedicated.

Such “twin” or “hybrid” objects are not concerned by the invention. They do not make it possible for data to be interchanged between the contact chip and the contactless chip. Nor can they operate fully simultaneously.

Mention is made below of the transmission terminals concerned by the invention. Such terminals are, for example, cellphones (e.g.: GSM (Global System for Mobile Communications); 3GPP (3^{rd} Generation Partnership Project); UMTS (Universal Mobile Telecommunications System); CDMA (Code Division Multiple Access); etc.) handheld personal digital assistants (PDAs), decoders, and computers.

They are made secure by at least one smart portable object.

It should be noted that the terminals concerned herein are not limited to terminals made secure by an object of “SIM” (Subscriber Identity Module) physical format. Certain embodiments of such terminals are capable (via means and steps) of establishing their own wireless communications.

Such communications comply, for example, with GSM, 3GPP, UMTS, CDMA Standards or with similar standards. It is for reasons of simplicity that, in the examples, the terminal and the object comply with Standard 3GPPTS11.11, in particular Chapter 412 thereof, as regards the “SIM” physical format.

Document FR 2 776 788 concerns memory cards having multiple applications, capable of being connected to terminal stations devoted to an application contained in the card. A ranked configuration table is produced in the card.

That table serves as access for recording, for each application, the first byte address of the message (ATR (Answer to Reset)—TOTAL SOLIDS) and, in a memory, the address of the message of other bytes. The configuration table is addressed by circular indexing at each “Reset” signal transmitted by the terminal station, and therefore feeds the messages (ATRs) to the terminal station for analysis. The indexing is maintained so long as the terminal station has not identified a message corresponding to the application to which it is devoted.

An aim of the invention is to enable a contact interface to operate simultaneously with a contactless interface, in all states and in all transitions useful to cohabitation (it is then said that it is “fully simultaneously used”) or even useful to data interchange, between a contact application and another, contactless application.

The invention also applies to a smart object including at least two interfaces. Such an object has, in particular, at least two contact interfaces or two contactless interfaces or a combination of both. For example, it can have an interface complying with one of the versions of ISO7816 and an interface for an object of the MMC (Multimedia Card), NFC, or USB (Universal Serial Bus) type.

Currently only one of the interfaces can be fully used at any one time. Using one interface inhibits or disturbs operation of the other interface in different manners.

It should be noted that the term “transaction” used herein designates transmission of at least one command from the terminal to the object, in the context of an application (e.g. payment, identity, telephony, access).

For example, while such a transaction, via the contactless interface, is in progress, the procedure for starting up an application in compliance with Standard ISO7816.3 via the contact interface and thus via the terminal made secure by means of the portable object, makes provision in particular for powering said object, for delivering a clock to it, and for activating resetting (RST) of the contact interface. Such resetting terminates the contactless application.

The various problems encountered are firstly outlined, and then explained in more detail in the description of embodiments and implementations, in particular as regards the states and transitions in question.

A problem then encountered is that the chip is currently reinitialized due to fact that resetting (RST) the contact interface is obligatorily activated.

To overcome that problem of obligatory resetting, the aim is to enable a transaction in progress via the contactless interface to continue to progress normally. In other words, the aim is to enable a contactless transaction in progress to be sustained while the contact interface is being brought into operation.

Another problem encountered concerns two transitions that are currently impossible.

In one of the currently impossible transitions, the object is processing an application for the benefit of the contactless interface (and for the benefit of the object), and is solicited by the terminal via the contact interface, so that said contactless application is processed simultaneously with another contact application that is to begin for the benefit of the terminal.

That applies, for example, when the terminal forms a cellphone (the contact application making a telephone conversation secure) and when the contactless application is for access to transport, premises, etc.

It is currently not possible to start a transaction (e.g. a telephone conversation) to be made secure via the contact interface while an application, such as an access authorization application, is already in progress via the contactless interface.

In general, currently, the contactless application is aborted suddenly, because starting an application for the benefit of the terminal via the contact interface causes the chip to be reset, and often causes data useful to the contactless application to be lost.

Symmetrically, the other currently impossible transition is also concerned. In such a transition, when the object is suddenly solicited via the contactless interface for an application, while an application via the contact interface for another application is already in progress, the contact application ceases.

In the example of a cellphone that is made secure, if, currently, the contact application ceases, in particular if the terminal is switched off while the access contactless application is in progress, said contactless application is aborted suddenly (reset, with data being lost).

That problem is thus how to manage simultaneously (to use fully) two concurrent applications, one of which is a contact application, and the other is a contactless application.

Currently, in these cases, the disappearance either of the contact interface resources, or of a solicitation or of a contactless asynchronous frame, disturbs the application in progress or is not taken into account.

Another problem encountered concerns a light sleep state in which the power supply coming from the contact interface of the object is limited (standards), while, simultaneously, resources coming from the two interfaces, namely the contact interface and the contactless interface, are required by the object.

Transitions to and from that state are also concerned.

It should be noted that a sleep state is, in common practice, relative to the ON states. Thus, in the case of a cellphone terminal, it is not uncommon for the object to be in the sleep state for 95% of the time for which the terminal is used.

Currently, in a light sleep state, the only resources available are a low electrical power supply, and an external clock signal coming from the contactless interface.

This is currently justified, e.g. by requirements for partitioning within the same object, between the highly secure contact applications (banking and telephone applications, etc.) and the contactless applications.

It is thus desirable to be able to have external resources simultaneously available, in particular in terms of electrical power. An advantage would then be to enable a contactless application to operate without consuming resources (power) coming from the contact interface when the standards imposed on the contact interface so require.

A problem similar to the above problems concerns the disappearance of the external clock source, causing a deep sleep state, while an application managed by the contactless interface has started.

This applies if the clock signal delivered by the terminal to the contact interface disappears. This is common in practice, since such a deep sleep state, i.e. a state with no external clock, is often longer than the above-mentioned light-sleep state.

Currently, the standards require, in particular, in that case, that the terminal connected to the contact interface cease to deliver the clock which would be necessary for the contactless application. With some objects, it is also possible to use the internal clock delivered by the chip independently of the clock from the interfaces.

Thus, for certain objects, the chip needs an external reference for using an internal clock: such an external reference is not currently available.

It is thus desirable to enable a contactless application to operate or at least to terminate correctly, without consuming resources (power and/or clock) coming from the contact interface beyond what the standards imposed on said contact interface require.

Another problem encountered concerns an object having two or more interfaces (a contact interface, a contactless interface, a USB interface, etc.) and serving for simultaneous use of at least two of the interfaces.

That problem is related to the fact that an application being executed in the object is not capable of determining which interfaces are active and in what state they are in (i.e. how many and which interfaces are delivering power supply and/or clock).

An on-board application in the object is not currently capable of taking the necessary decisions as a function of the states of the interfaces.

Therefore, such an application cannot operate correctly (e.g. canceling a transaction that has begun on an interface that is deactivated early). This applies during a pull-out.

For example, currently, in an object having multiple interfaces, its interfaces can be activated or deactivated, while an on-board application in the object is executed continuously without being interrupted.

Deactivation of one or more interfaces does not mean that the object is “OFF”: in reality, the object is “OFF” only when all of the interfaces are deactivated.

The invention aims to mitigate those drawbacks, in particular.

To this end, the provisions of the invention are stated below.

### SUMMARY OF THE INVENTION

The invention provides a method for sustaining operation of a smart portable object provided with a processor block having at least two communications and/or power supply interfaces that are contact and/or contactless interfaces, said method including a step for reinitializing the processor block.

Said method is remarkable in that it includes at least one step for delaying and/or faking re-initialization in the event that a call/communication or an application is being processed by the processor block.

In an implementation, the method includes at least one phase of detecting a reset (RST) transition capable of perceiving an interruption, e.g. in the form of an interruption processing routine.

In an implementation, the method provides at least one phase of delaying the reset instructions, which phase includes at least one memory zone address, with a chosen code; the memory zone receiving instructions coming from the chosen code, execution of which generates delay commands.

In an implementation, during the delay phase, execution of the instructions coming from the chosen code generates at least one of the following delay commands:
block the contact interface in its current state, e.g. by sending a single usual Answer-to-Reset (ATR) byte in response to activation of the reset;
continue the application using the contactless interface;
keep data useful to the contactless application in a memory without erasure;
verify the ON state of the contact interface; and
resume the functions required for the contact interface, e.g. by ending a series of Answer-to-Reset (ATR) bytes.

In an implementation, a delay command with functions being resumed takes place after a predefined number of clock cycles, e.g. approximately in the range 400 clock cycles to 40,000 clock cycles.

In an implementation, during a reset (RST) transition from a via the contactless interface operating state to the dual operating state, at least one immediate warning step is provided in addition to the keep data in a memory step.

In an implementation, the immediate warning step provides a phase of switching over between the resources so that they are drawn at least in part via the contactless interface.

In an implementation, the immediate warning step provides a phase of switching over between the resources so that they are drawn at least in part via the contact interface.

In an implementation, at the end of the warning step, interruptions are generated when a buffer receive memory is considered to be saturated, and can be processed by an operating system of the processor block, said interruptions, for example, notifying the application that data is available for processing.

In an implementation, when a contactless frame arrives, the warning step effects at least one phase of:
detecting said frame, e.g. by means of the presence of a contactless electrical power supply source;
transforming the frame into binary form, and initializing, for example, anti-collision processing; and
once the frame in question is considered as being correctly received and the preceding steps as being effected normally, the usual processing is authorized.

In an implementation, the other contactless standard is Standard ISO.IEC1443 relating to the contactless interface.

The invention also provides a device for sustaining fully simultaneous operation of a smart portable object having a dual interface, and provided with a processor block.

Said object is suitable for communicating with at least one electronic data transmission terminal for electronically transmitting data via a contact interface in compliance with Standard ISO7816.3, and also in contactless manner via a contactless interface and in compliance with another, contactless standard.

Said device makes provision as follows: the terminal is connected to the object via the contact interface so as to be made secure by the object; in the dual interface operating state, the contact interface and the contactless interface operate at the same time; the processor block including reset circuits for the purpose of reinitializing it when the contact interface is reset (RST).

Said device includes at least transaction-sustaining means, including at least one element for delaying and/or faking re-initialization ordered by the contact interface during a reset (RST) transition aiming to reinitialize the processor block.

In an implementation, the transaction-sustaining means include at least one element for detecting a hot reset transition, which element is capable of perceiving an interruption.

Said element is, for example, in the form of wiring suitable for perceiving an interruption, and for generating interruption processing.

In an implementation, the transaction-sustaining means include at least one delay element for delaying the reset instructions, which element includes at least one memory zone address, with a chosen code; the memory zone receiving instructions coming from the chosen code, execution of which generates delay commands.

In an implementation, the delay element includes at least one delay block for delaying by at least: time-delay blocking of the contact interface; continuing the application using the contactless interface; keeping data useful to the contactless application in a memory without erasure; verifying the ON state of the contact interface; resuming the functions required for the contact interface.

In an implementation, in “via the contactless interface” operation, in addition to the transaction-sustaining means, the device includes immediate warning means.

In an implementation, the warning means include at least one element for switching over the resources to the contactless interface.

In an implementation, warning means include, at their output, at least one element with a plurality of buffer receive memories and suitable for generating interruptions if a memory is considered to be saturated.

In an implementation, the warning means include at least one contactless frame detection element.

The invention also provides a transmit terminal having at least one connection via galvanic contact to a smart portable object having a dual interface, with a contact interface enabling the object to make the terminal secure.

The object is provided with a chip and is suitable for communicating with the terminal via the contact interface in compliance with Standard ISO7816.3; the object further being provided with a contactless interface communicating in compliance with another, contactless standard.

The terminal is suitable for taking part in implementing the method and/or for receiving an object as defined above including a device as defined above.

The terminal forms a cellphone (e.g. GSM; 3GPP; UMTS; CDMA, etc.) and/or a handheld personal digital assistant (PDA); and/or a decoder; and/or a computer.

The invention also provides a portable smart object suitable for taking part in implementing the method as defined above and/or for receiving an object as defined above including a device as defined above and/or suitable for being connected to a terminal as defined above.

Said object is a dual-interface object, and is provided with a chip (processor block); the object being suitable for communicating with at least one electronic data transmission terminal for electronically transmitting data via a contact interface in compliance with Standard ISO7816.3, and via a contactless interface and in compliance with another, contactless standard; the method making provision for: the terminal to be made secure by the object via the contact interface.

### BRIEF DESCRIPTION OF THE DRAWINGS

Implementations and embodiments of the invention are described below with reference to the accompanying drawings, in which:

FIG. 1 is a diagrammatic perspective view in longitudinal elevation showing an example of a smart portable object of the invention having a contactless interface;

FIG. 2 is a diagrammatic perspective view in longitudinal elevation showing an example of a terminal of the invention in the form of a portable digital assistant with cellular communications, made secure by inserting a smart portable object, with the following links: data input/output by galvanic contact; clock (“Clk”); ground (“Gnd”); power supply (“Vcc”); external antenna input/output; reset (“RST”);

FIG. 3 is a diagrammatic view showing operation of the invention, in which the object is inserted into a terminal which, in this example, is a cellphone, i.e. a mobile phone, or the like;

FIG. 4 is a diagrammatic plan view of a circuit portion inside an object of the invention and connected to a terminal to be made secure, with a diode for limiting power consumed from the contactless interface, and a logic gate for switching over between two power consumption modes (via galvanic interface or via contactless interface); this circuit portion thus forms selection means for selection by the application, and illustrates the appropriate steps, without contact with the external resources to be used (electrical power) in the event that a “ClockPause” (“ClkPause”) mode is triggered;

FIG. 5 is a diagrammatic plan view of a circuit portion inside an object of the invention and connected to a terminal to be made secure, with resistors for absorbing excess electrical power; and logic means for switching over between two power consumption modes (via galvanic interface or via contactless interface); this circuit portion forms, at least in part, means for selecting external resources to be used in order to make it possible for a contactless application to operate without consuming resources (power) coming from the contact interface when said contact interface so requires;

FIG. 6 is a logic diagram showing conventional transitions and steps inside an object inserted in a terminal, as observed in practice. Inaccessible conventional steps (2) and impossible conventional transitions (5) can be observed in particular;

FIG. 7 is a logic diagram similar to the diagram of FIG. 6, but that shows steps and transitions of the invention; and

FIG. 8 is a logic diagram of hard-wiring and software architecture of a chip for an embodiment of a smart portable object of the invention, in particular suitable for determining which interfaces are active and what state they are in.

### DETAILED DESCRIPTION

The description begins with the structures and infrastructures involved.

In the figures, reference 1 designates a smart portable object.

Such objects 1 are, for example, smart cards, electronic tickets, “dongles” or other modules such as proximity communications modules (e.g. Near Field Communications (NFC) modules) or semi-proximity modules (e.g. BlueTooth modules).

Such objects are secure objects that are non-disassemblable (i.e. tamperproof) and “portable” i.e. suitable for being put in the pocket because of their dimensions that are smaller than those of electronic data transmission terminals 2. Examples of such objects 1 are shown in FIGS. 2 to 5.

Such objects 1 are suitable for communicating remotely with one or more electronic data transmission terminals and/or with other objects 1, via a contactless interface 3.

Said interface 3 establishes contactless communications via an antenna 4. Some of said terminals 2, e.g. cellphones, are “handheld”, i.e. suitable for being carried quite easily, but they are not considered herein as being genuinely “portable”.

In the embodiments of the object 1, its contactless interface 3 has an antenna 4 which is at least in part:
integrated in a module of the object 1; and/or
integrated into a body 5 of the object 1; and/or
integrated into the terminal 2 to be made secure, and connected by galvanic link.

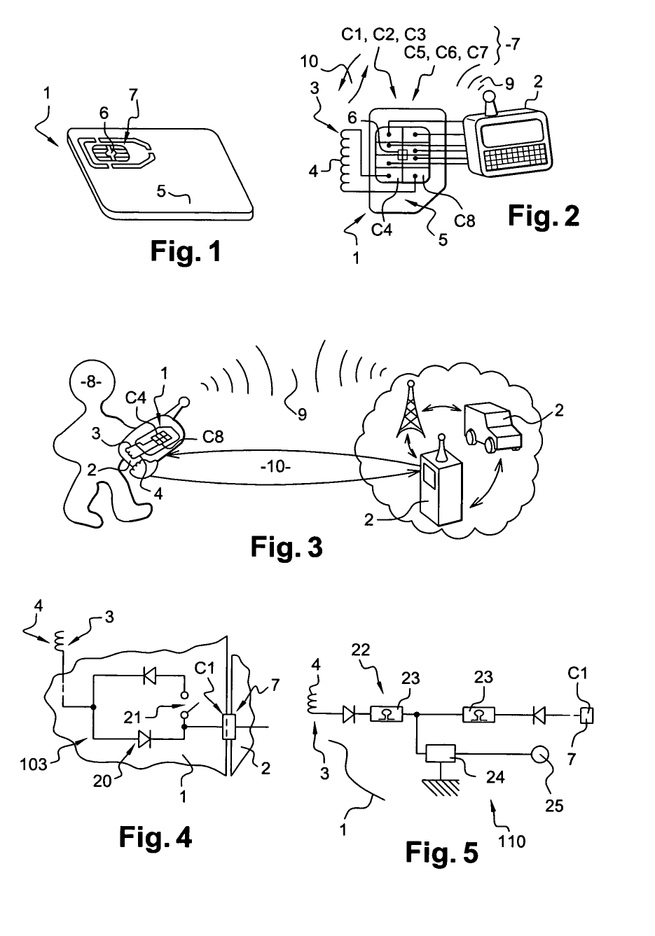

In FIGS. 1 to 3, the object 1 presents usual smart card shapes.

In this example, the object 1 comprises a card body 5 inside which or on the surface of which a chip 6 is inserted—optionally inside a module or package (FIG. 1); and the antenna 4 of the contactless interface 3 that is connected to the chip 6. A galvanic-contact interface 7 is also connected to the chip 6; it comprises a terminal block opening out onto to a main external surface of the body 5.

In FIG. 1, the body 5 presents an external aspect ratio as defined by Standard ISO7816, within which the object 1 proper is incorporated in detachable manner. Once the periphery of the body 5 has been detached, the object 1 proper presents an external aspect ratio as defined by Standard 3GPPTS11.11 (411 and 412) or the GSM (Global System for Mobile Communications) Standard, and referred to as a Subscriber Identity Module or “SIM”.

The terminal block of the interface 7 is also defined by said Standards. In this example, it has in the range six to eight contact regions or “pads” (FIG. 2) C1, C2, C3, C5, C6, and C7.

Optionally, the terminal block also has pads C4 and C8. However, for example, in Standard 3GPPTS11.11 (431), the pads C4 and C8 are not used in operating a conventional “GSM” cellphone terminal 2. In the standards, each of said pads C4 and C8 is connected to a respective port of the chip 6.

In the examples, the contactless interface 3 has an antenna 4 incorporated into the terminal 2 to be made secure, and connected via the galvanic link offered by the pads C4 and C8 of the contact interface 7.

In FIG. 3, the antenna 4 is external to the object 1, as appears from FIG. 3.

It should be noted that the data signals passing via the contact pads C2 to C7 in particular are digital signals of binary type.

Whereas the data signals in particular that pass via the pads C4 and C8 or that are transmitted directly to the chip 6 are modulated signals (radio signals, for example), coming from the antenna 4.

A description follows of the terminals 2.

The terminals 2 are, for example (FIG. 3) cellphones (e.g. GSM, 3GPP, UMTS, CDMA, etc.), handheld personal digital assistants (PDAs) as in FIG. 2, decoders and computers, in particular in networks, or even interactive terminal posts or access control equipment (transport, infrastructures, computer hardware, etc.). They are disassemblable and handheld, i.e. easily carriable, for example by a holder 8.

All of the terminals 2 of the invention, i.e. all of terminals made secure via the contact interface 7 via an object 1 as mentioned, are capable of communicating remotely with other terminals 2, e.g. those shown in the right of FIG. 3, remotely, i.e. in contactless manner.

The contactless communication of the terminals 2 made secure by an object 1 is represented by waves and designated by reference 9.

Another “transaction” or “application” communication, represented by arrows and designated by reference 10, is the contactless communication of which the object 1 is capable via its interface 3 and thus via the antenna 4.

The communication 9, also referred to as “application” communication, differs from the communication of which the object 1 is capable via its interface 3 and thus via the antenna 4.

The make-up of the communications or calls 9 and 10, e.g. of a cellphone terminal 2 equipped with an object 1 of the invention is described below.

For example, the communication 9 makes it possible for a secure purchase to be made by the terminal 2 and from a services server such as the services server shown bottom left, which is itself connected to the cellular reception terminal represented by the terminal 2 top left. The purchase is recorded in the form of values, in the object 1.

Via the antenna 4, the communication 10 then makes it possible to debit the values purchased in this way on the fly.

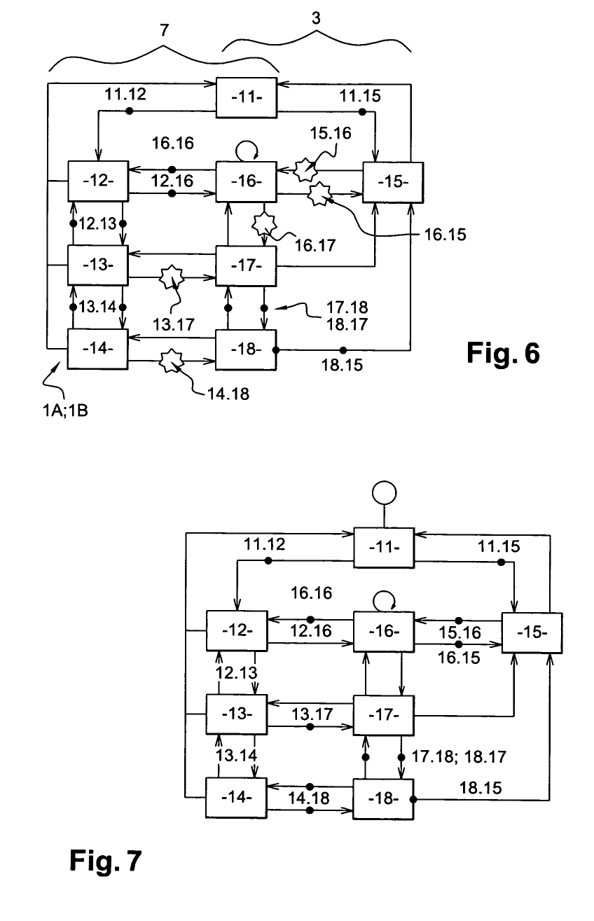

Operation of the object 1 and of the terminal 2 is described below with reference to FIG. 6 (current state of the art) and to FIG. 7 (invention).

This description is given to show how the invention makes it possible for a contactless interface 3 and a contact interface 7, i.e. a galvanic or resistive interface, to operate simultaneously and in secure manner in a smart portable object 1.

Likewise, the description also shows how the invention makes it possible for an application 10 whose data passes via the contactless interface 3 to operate in secure manner simultaneously with a distinct application 9 whose data passes via a contact interface 7.

The interfaces 3 and 7 are connected to the same chip 6 inside the object 1, and the applications via the contactless interface 10 and via the contact interface 9 are processed on the same chip 6.

As regards the chip 6 integrated into the object 1, it manages the interfaces 3 and 7, and also processes the data of the applications which, for reasons of simplicity, are referred to as the “contact” application 9 and the “contactless” application 10.

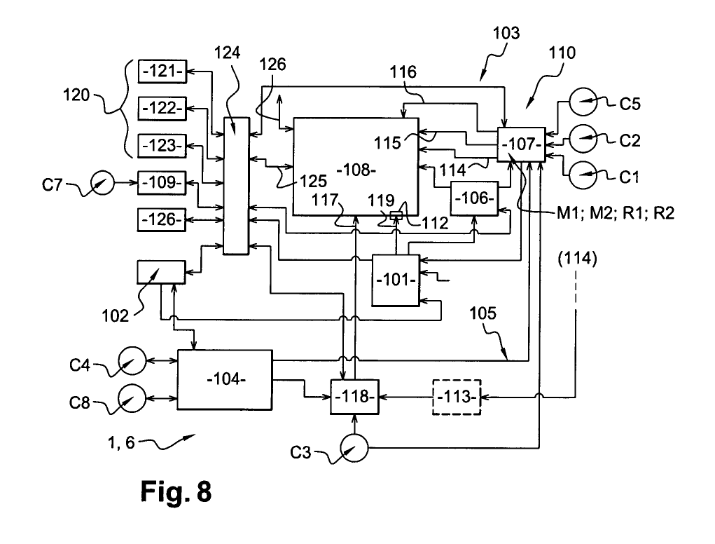

The structure of said chip 6 in an integrated substrate can be simplified as follows into functional blocks:
a memory block (designated at 120 in FIG. 8) with, in particular, a volatile memory referred to as a “RAM” for “Random Access Memory” (designated at 122 in FIG. 8), a non-volatile memory referred to as a “ROM” for “Read Only Memory” (designated at 121 in FIG. 8), and a re-writable memory referred to as an “EEPROM” for “Electrically Erasable Programmable Read Only Memory” (designated at 123 in FIG. 8);
a communications block (in FIG. 8, cf. blocks designated at 102 and at 109); it should be noted that, in FIG. 8, a data transfer bus 124 (also sometimes referred to as an “I/O” for “input/output” block) interconnects the block 120 and others including 102 and 109;
a central processing unit block or “CPU” (designated at 108 in FIG. 8); this processor block 108 implements data-processing that, depending on the case, takes the form of an operating system, applications, etc.; and
a specialized processing block, e.g. a coprocessor, a time delay (designated at 126 in FIG. 8); etc.

Also in this respect, see FIG. 8 and the relevant portions of the description below.

Depending on the instructions or values of the inputs/outputs to the chip 6, the chip is placed in various states, including:
an “OFF” state, shown at 11 in the Figures, such that the object 1 is off, without any data-processing or energy consumption taking place; and
an “ON” state (12-18) making it possible for the interfaces 3 and 7 to be managed, and for the applications (contact application 9 and contactless application 10) to be processed.

A transient standby or “IDLE” state that offers a practical solution for access to sleep states described below is not described in detail herein.

In the tables below, mention is made of the “VCC” (power supply voltage) and “RF” resources and of their possible states, which are explained below.

As a preliminary, it should be noted the “VCC” resource designates the electrical power supply to the object 1, which power supply comes from the contact interface 7.

In contrast, when an electrical power supply to the object 1 comes from the contactless interface 3, it is referred to as the “VDD” resource (and thus comes from the “RF” resource).

Firstly, for the “Vcc” resource, the “ON/OFF” states indicate that the contact interface 7 is respectively electrically powered or not electrically powered. In its ON state, the contact interface 7 electrically powers the object 1.

In its OFF state, the contact interface 7 no longer delivers any electrical power.

In its ON state (usually referred to as “VCC ON”), the contact interface 7 at least delivers electrical current to the chip 6, it being possible for the chip 6 to have consumption within the limits imposed that are usually sufficient for normal operation of the object 1.

This applies when the terminal 2 obtains that an application 9 using the contact interface 7 for interchanging data and resources is processed by the object 1.

This “VCC” power supply from the interface 7 is also suitable for being placed in the “Low Consumption” state as explained below.

In the figures, states (13, 14, 17, 18) are said to be “Low Consumption”, requiring a maximum value for power consumption by the object 1 via its contact interface 7. Thus, currently, among the low-consumption states, a distinction is made between:
light sleep mode (or “LOW POWER VCC”); and
deep sleep mode (or “LOW POWER VCC with ClkPause”), where “Clk” is short for “Clock”.

In Standard 3GPPTS11.11 in particular, the following two stringent power consumption requirements are imposed when power consumption is drawn from the resources via the contact interface 7:
in deep sleep mode, less than, i.e. no more than, 100 μA must be taken via the contact interface 7; and

in light sleep mode, less than, i.e. no more than 200 μA, must be taken via the contact interface 7.

With current chips 6, the sleep-mode low consumption requirements are complied with by interrupting the processing and by backing up the data necessary for subsequent resumption of the processing.

The necessary data is, in particular, the prior context (e.g. data, registers, etc.).

Currently, in the sleep state, the chip 6 cannot process a contactless application.

An aim of the invention is, once the chip 6 is (depending on the embodiments, by software means and/or hard wired means such as its CPU block) in sleep mode, to offer the possibility of achieving an ON state in which it is electrically powered in particular from the contactless interface 3, while complying with required consumption limits on the interface 7.

In addition, it is said that the chip 6 is in deep sleep mode with a Clock Pause (“ClkPause”) when said chip 6 is in a state similar to the light sleep state, but without having a clock resource coming from the contact interface 7.

Secondly, the “RF” resource indicates the state (“ON/OFF”) of the contactless interface 3, which is of the Radio Frequency (RF) type in the example of Standard ISO14443.

In its ON state, the contactless interface 3 performs a contactless, i.e. remote, transaction, such as:
transmission and/or
reception of modulated signals (data, resources); and
processing of an application using, in particular, the data from those signals.

In its OFF state, said contactless interface 3 performs no transaction.

Thirdly, the “Sleep” state indicates (“Yes/No”) respectively whether or not the chip 6 is in the low-consumption state on the contact interface 7.

Fourthly, the “ClkPause” state indicates (“Yes/No”) respectively whether or not the chip 6 is supplied with an external clock signal, during the low-consumption state, from the contact interface 7.

TABLE 1
(situation with a known object 1A):

| | | | | | | | | | | Transitions | |
|---|---|---|---|---|---|---|---|---|---|---|---|
| | Initial State | | | | | | | | | FIG. 6 & 7 | |
| | Vcc | RF | Sleep | ClkPause | Vcc | RF | Sleep | ClkPause | 1A | From: | To: |
| | | | | | Final State | | | | | | |
| Transition | ON | OFF | no | no | ON | ON | no | no | OK | 12 | 16 |
| on RF with | ON | ON | no | no | ON | OFF | no | no | OK | 16 | 12 |
| Vcc ON | | | | | | | | | | | |
| Transition | OFF | ON | no | no | ON | ON | no | no | NOK | 15 | 16 |
| on Vcc with | ON | ON | no | no | OFF | ON | no | no | NOK | 16 | 15 |
| RF ON | | | | | | | | | | | |
| ON/OFF | ON | ON | yes | no | ON | ON | no | yes | NOK | 17 | 18 |
| ClkPause | ON | ON | yes | yes | ON | ON | no | no | NOK | 18 | 17 |
| with RF ON | | | | | | | | | | | |
| Transition | ON | OFF | yes | yes | ON | ON | yes | yes | NOK | 14 | 18 |
| on RF with | ON | ON | yes | yes | ON | OFF | yes | yes | NOK | 18 | 14 |
| ClkPause | | | | | | | | | | | |
| ON/OFF | ON | ON | no | no | ON | ON | yes | no | NOK | 16 | 17 |
| sleep with | ON | ON | yes | no | ON | ON | no | no | NOK | 17 | 16 |
| RF ON | | | | | | | | | | | |
| Transition | ON | OFF | yes | no | ON | ON | yes | no | NOK | 13 | 17 |
| on RF with | ON | ON | yes | no | ON | OFF | yes | no | NOK | 17 | 13 |
| sleep mode | | | | | | | | | | | |
| Transition | ON | ON | yes | no | OFF | ON | yes | yes | NOK | 17 | 15 |
| on Vcc with | ON | ON | yes | yes | OFF | ON | yes | yes | NOK | 18 | 15 |
| RF ON & low | | | | | | | | | | | |
| consumption | | | | | | | | | | | |

| | | | | | | | | |
|---|---|---|---|---|---|---|---|---|
| mode | | | | | Action | | | |
| Impact on | ON | ON | no | no | Hot Reset on Vcc | NOK | 16 | 16 |
| circuits | | | | | | | | |
| reset | | | | | | | | |

TABLE 2
(situation with a known object 1B):

| | | | | | | | | | | Transitions | |
|---|---|---|---|---|---|---|---|---|---|---|---|
| | Initial State | | | | | | | | | FIG. 6 & 7 | |
| | Vcc | RF | Sleep | ClkPause | Vcc | RF | Sleep | ClkPause | 1B | From: | To: |
| | | | | | Final State | | | | | | |
| Transition | ON | OFF | no | no | ON | ON | no | no | OK | 12 | 16 |
| on RF with | ON | ON | no | no | ON | OFF | no | no | OK | 16 | 12 |
| Vcc ON | | | | | | | | | | | |
| Transition | OFF | ON | no | no | ON | ON | no | no | NOK | 15 | 16 |
| on Vcc with | ON | ON | no | no | OFF | ON | no | no | NOK | 16 | 15 |
| RF ON | | | | | | | | | | | |
| ON/OFF | ON | ON | yes | no | ON | ON | no | yes | NOK | 17 | 18 |
| ClkPause | ON | ON | yes | yes | ON | ON | no | no | NOK | 18 | 17 |
| with RF ON | | | | | | | | | | | |
| Transition | ON | OFF | yes | yes | ON | ON | yes | yes | NOK | 14 | 18 |
| on RF with | ON | ON | yes | yes | ON | OFF | yes | yes | NOK | 18 | 14 |
| ClkPause | | | | | | | | | | | |
| ON/OFF | ON | ON | no | no | ON | ON | yes | no | NOK | 16 | 17 |
| sleep with | ON | ON | yes | no | ON | ON | no | no | NOK | 17 | 16 |
| RF ON | | | | | | | | | | | |
| Transition | ON | OFF | yes | no | ON | ON | yes | no | NOK | 13 | 17 |
| on RF with | ON | ON | yes | no | ON | OFF | yes | no | NOK | 17 | 13 |
| sleep mode | | | | | | | | | | | |
| Transition | ON | ON | yes | no | OFF | ON | yes | yes | NOK | 17 | 15 |
| on Vcc with | ON | ON | yes | yes | OFF | ON | yes | yes | NOK | 18 | 15 |
| RF ON & low | | | | | | | | | | | |
| consumption | | | | | | | | | | | |

| | | | | | | | | |
|---|---|---|---|---|---|---|---|---|
| mode | | | | | Action | | | |
| Impact on | ON | ON | no | no | Hot Reset on Vcc | NOK | 16 | 16 |
| circuits | | | | | | | | |
| reset | | | | | | | | |

Above tables 1 and 2 show the situation encountered in these states or transitions with current objects (1A and 1B).

By comparing these tables with FIG. 6, it is also possible to observe the following states and transitions in addition to the possible states and transitions (designated by “OK”), as in FIG. 6:
two impossible states (17; 18) that are designated by “NOK”; and
twelve impossible transitions (15.16; 16.15; 17.18; 18.17; 14.18; 18.14; 16.17; 17.16; 13.17; 17.13; 17.15; 18.15) that are designated by “NOK”.

With these definitions and illustrations of the known techniques being stated, the description below returns to FIGS. 6 and 7.

In FIGS. 6 and 7, elements that are identical are designated by like references and are described once only, for reasons of simplicity. The left column of the diagrams of FIGS. 6 and 7 shows the states related to operation of the contact interface 7. Whereas the right column shows the states related to operation of the contactless interface 3.

It should be noted that, by default, when an inverse transition is not mentioned, such an inverse transition is merely a return path, and therefore does not require any additional explanation.

It should also be noted that, in FIG. 6, the (five) impossible transitions are shown by star-shaped outlines. Whereas the (two) states that are impossible to reach are shown by hatched frames.

In addition to a state 11, the middle column (states 16, 17, and 18) describes states desired for an object 1 fully used simultaneously according to the invention.

The states are shown by boxes, and the transitions between the possible or impossible states are shown by directional arrows.

The OFF state 11 corresponds, in the case of a cellphone terminal 2, to the situation in which said terminal 2 is switched off and cannot be used as it is by the holder 8.

Starting from the OFF state 11, a transition 11.12 in FIGS. 6 and 7 makes it possible to reach a state 12 in which the object 1 is operating via a contact interface 7 (referred to as the “via-the-contact-interface operating state”).

In the example of the cellphone terminal 2, said usual transition 11.12 corresponds to the action of the holder 8 switching on his or her terminal 2.

In this example, the terminal 2 then sends to the object 1, via the terminal block of the interface 7, a reset signal (RST). The first eight-bit bytes of an Answer-to-Reset protocol (“ATR”) are then sent by the object 1 to the terminal 2 via the interface 7.

When these interchanges lead to a positive result, the object 1 is capable of directly processing orders coming from the interface 7, and from the terminal 2 that is made secure by the object 1.

Starting from the via-the-contact-interface operating state 12, a transition 12.13 makes it possible to reach a low-consumption waiting or standby state 13.

That is to say the above-mentioned light sleep state 13 in which the object 1 is waiting to be solicited from the contact interface 7.

Typically, the standby state 13 is put in place when the object 1 has finished processing (energy saving mode). It is recalled that said state 13 requires reduced energy consumption by the object 1 via the interface 7.

Starting from the state 13, a transition 13.14 (FIGS. 6 and 7) makes it possible to reach a deep sleep state 14 with a clock pause, as mentioned above. In this state 14, the object 1 is waiting for solicitation from the contact interface 7. It is in general the terminal 2 that initiates the clock (CLK) interruptions between two commands. For example, a clock interruption towards the state 14 is required after “n” clock cycles (e.g. approximately in the range 1800 cycles to 2000 cycles), after a command.

Reference is made below to the right column of FIGS. 6 and 7, i.e. to the states and transitions relative to the contactless interface 3.

Starting from state 11, the transition 11.15 corresponds to the case when the antenna 4 is exposed to the field of a contactless modulated signal (e.g. RF), said signal carrying resources (power and clock) and data in the form of frames.

This is the situation in which the antenna 4 is exposed to a contactless modulated field (power and data), but in which the object 1 does not have any resources coming from the contact interface 7.

This transition 11.15 leads to the via-the-contactless-interface operating state 15. Then, the object 1 is capable of directly processing the orders coming from the interface 3.

It should also be noted firstly that, in the objects 1, the choice of transitions is exclusive, starting from the OFF state 11, between the following respective states:
via-the-contact-interface operation (12); and
via-the-contactless-interface operation (15).

Secondly, unlike for the via-the-contact-interface operating state 12, for the contactless operating state 15, in the above-mentioned standards, there is no maximum power consumption constraint.

The state 16 is refereed to as the “dual interface operating state”. In FIGS. 6 and 7, this state 16 corresponds to the situation in which the contact interface 7 is in operation, and in which the other, contactless interface 3 is also in operation.

This state 16 is the only currently possible dual operating state, i.e. the only possible state in which the contact interface 7 and the contactless interface 3 operate at the same time.

It should be emphasized that in currently available objects 1, only the transitions 12.16 and 16.12 are possible (OK). Conversely, transitions from the state 15 and from the new state 17 to the state 16 are impossible (NOK).

With these transitions 12.16 and 16.12, it is necessary to have the contact interface (7) and the contactless interface (3) cohabit, and also to have the applications 9 and 10 using respective ones of the interfaces cohabit.

Because, in particular, of the above-mentioned impossible transitions, it is nevertheless not possible, with current interfaces and applications, to say that full and simultaneous use can be achieved.

The transition 12.16 corresponds to the case, also in the example of the cellphone terminal 2, in which the contact interface 7 operates (resource and application 9) while the antenna 4 penetrates into a field perceived by the contactless interface 3 (transaction 10).

Reference is made below to the currently impossible transition 16.16.

The problem encountered during this “hot reset” transition 16.16 is to make it possible not actually to reinitialize the chip 6, unlike the effect currently induced by the reset signal (RST) received from the contact interface 7.

It should be noted that the terms “hot” and “cold” are defined in particular in Standard ISO7816.3.

The aim is for a transaction that is in progress via the contactless interface then to continue to proceed normally.

To this end, the invention proposes means 101 and/or steps for sustaining the contactless transaction while the contact interface 7 is being brought into operation.

These means are circuits inside the chip 6 and/or logic instructions.

Within the state 16, the invention makes distinctions between various cases, depending on the origin of the resources consumed by the chip 6.

Currently, in the state 16, said chip 6 cannot undergo any modification in the origin of its essential resources (in particular power supply and clock) without being subjected to an untimely reset.

With the invention, depending on the cases:
the power supply to the chip 6 can come from:
   VCC, i.e. from the contact interface 7;
   the antenna 4; or
   a combination of origins, in particular of the above origins, e.g. a function F[VCC and/or VDD)];
the clock delivered to the chip 6 can come from:
   the contact interface 7;
   the antenna 4; or
   an internal clock generator, such as the internal clock generator that, in FIG. 8, is designated at 113, and that is described in detail below.

The invention thus makes it possible, within the state 16 and thus during simultaneous processing of the applications, to change the origin of the power supply and/or of the clock, depending on the needs of the moment, and without any risk of an untimely reset occurring.

In an implementation of the invention, the means 101 and/or steps for sustaining the transaction (and/or steps of the same name) are also referred to as “Fake Resets”.

These sustaining means and/or steps (101) provide at least one physical element and/or logic phase of delaying and/or faking resetting, ordered by the contact interface 7 when it is switched on or when analogous resetting situations take place.

In an example, said sustaining means 101 and/or steps include(s) at least one element and/or phase of detecting a reset, in the example of FIG. 8 in the form of wiring suitable for perceiving an interruption, and for generating interruption processing.

In FIG. 8, the sustaining means 101 are connected as input to a functional block 107 which effects the detection in question. This block 107 is described in more detail below.

In an implementation, a sustaining logic phase also effects reset detection. This logic phase includes an interruption processing routine.

It should be noted that, on initially switching on the chip 6, regardless of its source (interface 3 or interface 7), resetting must nevertheless be possible. Such a reset aims to ensure that the chip 6 starts cleanly, and is not effected by the sustaining means 101 and/or sustaining steps.

Such sustaining means 101, shown in FIG. 8, are sometimes referred to in practice as an “interrupt controller block”.

In an implementation, at least one element and/or phase of delaying the reset instructions of the sustaining means (101) and/or step, include a memory zone address, with a chosen code.

This memory zone receives instructions coming from the chosen code, execution of which generates, e.g. by means of resources from the means 101, commands for performing the following, depending on the implementations:
blocking the time delay via the contact interface 7, e.g. by sending a single usual Answer to Reset (“ATR”) byte in response to activation of the reset; and/or
continuing the application using the contactless interface 3; and/or
keeping data useful to said contactless application in a memory; and/or
verifying the ON state of the contact interface 7; and/or
resuming the functions required for the contact interface 7, for example by sending a series of Answer-to-Reset (“ATR”) bytes.

For example, such resumption takes place after a predefined number of clock cycles, e.g. of the order of 400 to 40000 clock cycles.

With current objects 1, a reset (RST) transition 15.16, from the via-the-contactless-interface operating state 15 to the dual interface operating state 16 is impossible.

In fact, currently, after such a transaction 15.16, untimely resetting is inevitable.

The same applies even for an inverse transition 16.15.

This transition 15.16 is also made possible by the invention.

During the transition 15.16, the object 1 is initially processing an application for the benefit of the contactless interface 3, and the object 1 is solicited by the terminal 2 via the contact interface 7.

This applies, for example, for a terminal 2 forming a cellphone (the contact application making a telephone conversation secure), and when the contactless application is aimed at access, to transport, premises, etc.

It is currently not possible to start a transaction to be secured by the object 1 via the contact interface 7 while an application such as access authorization is already in progress via the contactless interface 3.

In general, currently, the contactless application is aborted suddenly, because the start of an application for the benefit of the terminal 2 via the contact interface 7 causes the chip 6 to be reset (RST).

And it often causes loss of data useful to the contactless application.

In order that, during such a transition 15.16, said application, for the benefit of the contactless interface 3, is processed simultaneously with the other application for the benefit of the contact interface 7 that is to start, the invention provides, in implementations, immediate warning means 102 and/or an immediate warning step.

The warning means 102 and/or the warning step are then provided in addition to or instead of the sustaining means 101 and of the sustaining step. The warning means 102 and/or the warning step then ensure that the chip is operating properly in state 16.

In addition, following the transition 16.15, the object 1 is initially solicited via the contact interface 7 for one application, and simultaneously via the contactless interface 3 for another application. Currently, if the contact application then ceases, untimely resetting occurs.

In the example of the secure cellphone terminal 2, if, currently, the contact application ceases, in particular if said terminal 2 is switched off while the access contactless application is in progress, said contactless application is aborted suddenly (with resetting and loss of data ensuing).

The problem of the transition 15.16 alone thus reduces to simultaneously managing two concurrent applications, which is achieved by the warning means 102 and/or by the warning step.

Whereas disappearance of resources from the contact interface 7 (16.15) disturbs the application in progress, by causing untimely resetting. This is mitigated by the sustaining means 101 and/or sustaining steps.

Since an aim of the invention is to avoid untimely resetting, a few practical examples of resulting advantages are given below.

Currently, the dual interface operating state 16 is achievable via the transition 12.16 exclusively.

For this sole possible transition 12.16 to the state 16, and for the inverse transition (to the state 12), a message must be transmitted to the application (respectively 10 and 9, for the inverse transition).

The impossible transition 15.16 indicates that, in the example of a cellphone terminal 2, it is thus impossible to bring the terminal 2 into operation while a transaction 10 is in progress via the contactless interface 3.

One illustration is the purchase of a transport ticket via the contactless interface 3.

At this time, if the holder 8 brings its terminal 2 into operation in order to have a telephone call 9, the risk is then that the data of the transaction 10 in progress via the contactless interface 3 might be lost, and that inconvenience might be caused to the holder 8 (access to the means of transport refused or delayed).

In current objects 1, the chip 6 causes resetting (RST) to take place as soon as a transition takes place to an “ON” state or to an “OFF” state of the power supply “VCC” via the contact interface 7.

The other impossible transition 16.15 corresponds (in the example of the cellphone terminal 2) to the case when, once the dual interface operating state 16, is reached from state 12, the power supply to said terminal 2 (batteries, storage cells, chargers, collectors, etc.) is interrupted during a transaction 10 via the interface 3.

Here too, the transaction via the contactless interface 3 is suddenly interrupted, with the risks run in that case (loss of data, inconvenience, etc.).

It is explained below that the solutions proposed by the invention for both of the transitions 15.15 and 16.15 avoid all sudden interruption in the transaction in progress via the contactless interface 3.

As regards the transition 15.16, such avoidance is obtained, for example, by sending a warning signal concerning said transition, via the warning means 103 and/or the warning step, to the operating system in charge of managing said transaction (i.e. application 9 and/or application 10).

Once warned in this way, the operating system is capable of effecting said transition 15.16 while preserving the communications, data, etc.

Depending on the case, said transition 15.16 uses: “clean” interruption of one or other of the applications 9 or 10; a pause on one or other of the applications 9 or 10; timed-delayed switching back and forth between the applications 9 or 10, etc.

In an implementation, the warning means 102 and/or steps make it possible for the contactless application to back up essential data (i.e. data necessary for subsequent resumption).

In examples, in order to authorize the transition 15.16, the invention makes provision for the contactless transaction 10 to be paused, and for a message to be sent to the application 9 in order to indicate to it that the contact interface 7 is ON. The application 9 then processes the data coming from said contact interface 7.

Any untimely resetting is inhibited, and then a request is sent for sharing the resources (in particular processing resources) as soon as possible between the two applications 9 and 10 present (initial contact application and incoming contactless transaction).

The transition 16.15 of the invention provides (via means and/or steps) an element and/or a phase of switching over the resources so that the they are taken via the contactless interface 3.

In addition, immediate warning means 102 take, as shown in FIG. 8, the form of a functional block sometimes referred to as a “UART” (Universal Asynchronous Receiver/Transmitter).

Said means 102 represent serial communications peripherals that comply with Standard ISO7816 for the contact interface 7, and with a standard such as ISO14443 for the contactless interface 3.

As output from the immediate warning means 102 and/or the immediate warning logic step 102, interruptions are generated in particular when a buffer receive memory is considered to be saturated.

That is to say that a protocol frame has been correctly received and can be processed by an operating system of the chip 6.

This makes it possible, in particular, for the application using the contact interface 7 to perform certain processing without being disturbed by receiving data. Such interruptions indicate to the application that the data is available for processing.

In the example of a contactless frame arriving, the warning means 102 and/or the warning step include(s) at least one initialization element/phase that comprises:
detecting a contactless source; then
detecting data coming from a demodulation; and
anti-collision.

In a modulator-demodulator (MODEM), a contactless source is transformed into binary form; initialization is then performed, and, for example, anti-collision processing is performed; and, once the frame is considered to be correctly received and the preceding steps have taken place normally, usual processing is authorized.

In FIG. 8, a functional block 104 groups together the modulator-demodulator (MODEM) and anti-collision processing elements. It can be seen that, in this example, the block 104 is connected via the contact pads C4 and C8.

Mention is made below of a standby field pick-up state 17 shown in FIGS. 6 and 7.

This state 17 is impossible to reach (in particular from states 13 and 16) with a current object 1.

This state 17 is often reached by means of the invention, from the light sleep state 13. In this state 17 close to the light sleep state, the power supply coming from the contact interface 7 is limited, whereas resources coming from the contactless interface 3 are simultaneously required by the object 1.

In order to illustrate this state 17, the description below returns to the example of the cellphone telephone made secure by an object 1 whose contactless interface 3 is capable of processing “contactless” applications.

This state 17 appears when an application is operated for the contactless interface 3, while the electrical power supply for the object 1 from its contact interface 7 is limited.

In this state 17, the contact application is on standby, waiting for a command from the terminal 2, in the context of the transaction in progress.

In other words, an application is processed via the contactless interface 3, whereas the object 1 is, via its contact interface 7, in light sleep mode. Then, the electrical power supply for the object 1 via the contact interface 7 becomes non-compliant with the constraints, in particular defined by standards.

Ideally, the invention makes it possible, in the state 17, for a contactless application to operate without consuming resources (power) coming from the contact interface 7, when the standards imposed on the interface 7 so require.

With the invention, the object 1 draws its power supply from the contactless interface 3, by rectifying the modulated signal picked up by the antenna 4. As explained above, existing standards prevent the use of power from the interface 7, and thus from the terminal 2, in certain cases, including the following cases.

In order for the object 1 to draw its electrical power from the contactless interface 3, an implementation of the invention provides steps and/or means 103 providing immunity from variations in power supply source.

FIG. 4 shows a circuit portion in an object 1 of the invention, connected to a terminal 2 to be made secure. The means 103 and/or steps for providing immunity from variations in power supply source comprise, in this implementation, such a circuit portion, with:
a diode 20 for limiting the power consumed from the contactless interface 3; and
a logic gate 21 switching over between two power consumption modes (via the contact interface 7 or via the contactless interface 3).

This implementation of the immunity means 103 and/or of the immunity steps 103 thus makes it possible for the operating system to select external resources to be used (electrical power) in the state 17 that is compatible with light sleep mode.

Typically, according to the invention, the immunity means and/or steps 103 choose the origin of the power supply to the chip 6 from among the following:
VCC, i.e. from the contact interface 7;
the antenna 4; and
a combination of origins, in particular of the above origins, e.g. a function F[(VCC and/or VDD)].

In another implementation, the immunity means 103 are provided with a wired mechanism (referred to below as M1—cf. FIG. 8) which makes it possible to detect the presence of a power supply coming from the contact interface 7 (Vcc) and of a power supply coming from the contactless interface 3 (Vdd).

By using this mechanism (M1), the state (cf. Tables 1A and 1B: ON/OFF) of the power supplies (Vcc and Vdd) is indicated by means of two registers (referred to below as R1 and R2—cf. FIG. 8).

Any modification in the registers R1 and/or R2 (i.e. the appearance or the disappearance of one and/or the other of the power supplies referred to as “Vcc” or “Vdd”) is expressed by a warning signal (e.g. in the form of an interruption).

After having consulted the registers R1 and R2, or after having been warned of a change of state of one of the two registers (interruption), the operating system of the chip 6 then selects the power source used (Vcc or Vdd).

Another wired mechanism (referred to below as “M2”, cf. FIG. 8) is present in the chip 6. This wired mechanism (M2) makes it possible to guarantee that only the selected single source serves to power the chip 6.

If this is put into application, in the case, for example, of the transition 13.17, the following is, for example, obtained:
the contactless interface 3 is brought into operation while the chip 6 is in the light sleep state (13) at its contact interface 7; then
means 103 (mechanism M1) that detect the contactless frame or field (RF), warn the chip 6 by an interruption, and update the registers (R1 and R2); then
the operating system, warned by the interruption issued by the means 103 and/or by the equivalent logic step, switches over the power supply of the chip 6 to the contactless interface 3 (by means of M2), thereby guaranteeing acceptable consumption via the contact interface 7; then
the processing of the transaction via the contactless interface 3 (RF) can then take place, while the chip 6 remains in light sleep mode via the contact interface 7.

Another embodiment of the immunity means 103, shown in FIG. 8, is described below.

In this embodiment, the means 103 comprise a functional block 107, referred to as the power supply controller or “PWR”, and another functional block 106 forms a sleep controller.

The mechanisms M1 and M2, and the registers R1 and R2 and/or the equivalent logic steps correspond, in the embodiments and implementations of the invention, functionally to said block 107.

The following contact pads are connected, as inputs in this example, to the block 107 of the means 103:
C1 (VCC: power supply from the contact interface 7);
C2 (RST: reset);
C3 (CLK: clock from the contact interface 7); and
C5 (GND: grounding via the contact interface 7).

The power supply controller block 107 of the means 103 serves to power the chip 6 with the appropriate power and voltage. It also serves to inform the chip 6 of appearance and/or of disappearance of power supply resources coming from the contact interface 7 or from the contactless interface 3.

To this end, the above-mentioned inputs make it possible to receive firstly a voltage coming from the contact interface 7 via the pad C1 (Vcc). Secondly, said inputs make it possible, via wiring 105, to convey a voltage (Vdd) coming from the modulator-demodulator of the means 104 from the contactless interface 3.

The inputs of the means 103 also receive external clock signals (CLK) and reset (RST) request signals for detecting the reset (RST) sequences complying with the constraints required by the standards because of the use of the contact interface 7.

For example, in terms of signal, the inputs of the means 103 take the form of a time combination of voltage coming from the contact interface 7 (Vcc), of digital clock signal (CLK), and of digital reset signal (RST).

The block 107 (PWR) also contains at least one configuration/information register (in this embodiment, the registers R1 and R2 in FIG. 8) enabling the application executed by the processor block 108 (CPU) of the chip 6, to which the block 107 is connected, to:
determine which voltage source is available (via 3 and/or 7); and
select the source (via 3 and/or 7) to be used in a given situation for powering the chip 6 (i.e. via 3 or 7 or a combination thereof).

The block 107 and/or phase ofming the power supply controller for the means 103, as shown, also has outputs.

During normal operation, the block 107 is in a state in which at least one external voltage source (via 3 and/or 7) is present, and said block 107 delivers to the entire chip 6 an appropriate voltage, generated from one of (or form a combination of both of) the input voltages (via 3 and/or 7) as a function of the selected configuration.

The appearance or disappearance of voltage sources (via 3 and/or 7) does not disturb the output voltage, so long as at least one available voltage, or even a combination of the two voltages, is sufficient.

Thus, the block 107 and/or phase ofming the power supply controller do(es) not generate a reset signal for the block 108 (CPU) so long as this condition is satisfied.

Naturally, unless an on-board power source is provided in the object 1, such as a solar collector or a storage cell, if both of the sources (via 3 and/or 7) disappear, the chip 6 is no longer powered.

It should be noted that, in implementations and embodiments, the block 107 and/or phase ofming the power supply voltage deliver(s) warnings which indicate appearance of a power supply coming from the contactless interface 3.

Once warned in this way, the operating system triggers initialization of the contactless transaction, by the functional block 104 and/or by equivalent logic phases. Then the operating system resumes the processing of the contact application.

This initialization sequence is processed as a background task without disturbing the contact application. Once it is finished, and once the contact frame has been received entirely, the warning means 102 and/or logic step then warn(s) the operating system that the data to be processed is available for the contactless application.

The block 107 generates an interruption towards the block 101 that, in this example, acts as an interruptions controller, when the state of availability of the sources (via 3 and/or 7) changes, and more particularly in the following transitions:
power supply via the contact interface 7: transition 16.15 from ON to OFF: pertinent only if the chip 6 is still powered via the interface 3;
power supply via the contactless interface 3: transition 13.17 or 14.18 from OFF to ON: the interruption takes place only if the voltage via the contactless interface 3 is greater than a threshold voltage; for example, the value of the threshold voltage is slightly greater than a minimum operating voltage of the chip 6 that is sometimes referred to a the “POR” (Power on Reset); and
power supply via the contactless interface 3: transition 17.13 or 18.14 from ON to OFF: the interruption takes place when the voltage received via the contactless interface 3 is less than a threshold voltage.

For example, the value of the critical voltage is predetermined so as to transfer (as rapidly as possible without any risk of the contactless power supply (i.e. via 3) completely ceasing) the power supply from the contactless interface 3 to the power supply coming from the contact interface 7.

The chip 6 is then placed in sleep mode.

It should be noted that a pull-out and thus the disappearance of the energy source coming from the contactless interface 3, is not instantaneous but rather it is progressive.

In other words, warning signs of a pull-out are easily perceptible by the object 1. In the example, firstly, during a pull-out, a reduction is observed in the power available via the antenna 4, to below the threshold voltage. A certain lapse of time necessarily elapses before the power coming from the antenna 4 becomes equal to or less than the minimum operating voltage of the chip 6.

However, if the lapse of time proves to be insufficient for the operating system to switch over between the origins of the resources (in an implementation via the selection means and/or steps 103), it is sleep control means and/or steps 106 that take over.

For example, in this situation, the selection means and/or steps 103 take charge of the switch-over, and avoid the object 1 being totally deprived of power resources, which would cause untimely resetting to take place.

For this purpose, the transfer should take place more rapidly than the pull-out (causing the transition 17.13 or 18.14 from ON to OFF) of the energy source coming from the contactless interface 3.

Power supply controller means (wiring) and/or steps (logic) such as the block 107 perform this transfer or switch-over in implementations of the invention.

The description below returns to the states and more particularly the transitions in which the selection means 103 and/or the selection steps act:
Power supply via the contact interface 7: transition 15.16 from OFF to ON: only if the object 1 and thus the chip 6 are already powered via the contactless interface 3.
A transition (16.16) or reset sequence (RST) caused by the contact interface 7, with the power supply via the contact interface 7, while hot.

Concerning the applications via the contact interface 7 and via the contactless interface 3, the signals generating interruption to the block 101 by the block 107 make it possible:
While the signals coming from the contactless interface 32 are being processed, to notice that the contact interface 7 is soliciting processing, and to decide to send the first Answer-to-Reset (ATR) bytes in reply to a reset request.

An alternative would be to have the terminal 2 transmit to the object 1 a packet high-level command interchanged between two applications, and referred to as an “APDU” (for “Application Protocol Data Unit”, in Standard ISO7618).
While processing is taking place via the contact interface 7, to notice that the contactless interface 3 is soliciting processing, and to decide to launch the initialization sequence of the appropriate contactless protocol.
While the two interfaces, namely the contact interface 7 and the contactless interface 3, are operating simultaneously, to notice the loss of power supply on one of the two interfaces 7 or 3 (“semi-pull-out”).
While the contact interface 7 is in the light sleep, or even deep sleep, mode, to perform the transition 17.13 or 18.14 so that the contact interface 7 is in the sleep mode, when the power supply via the antenna 4 disappears.

In order to ensure that the chip 6 and its processor block 108 are brought into operation properly, when said block 108 receives a first power supply source—from one of the two interfaces 7 or 3—(the chip 6 going from a sleep state to one of its “ON” states), the power supply control means 103 and/or power supply control logic steps (e.g. the block 107 in particular) send(s) an initialization signal to the connector for resetting the block 108 (CPU).

This makes it possible to cause it to be implemented in particular by being switched on from the source that is determined via the means 103.

Conversely, in certain situations, it appears preferable for the means 103 to inhibit resetting.

Thus, a digital signal coming from the contact pad C2 (RST) is, in the example shown in FIG. 8, perceived by the controller means and/or steps (the block 107 in the embodiment shown in FIG. 8) because a link is provided towards these means and/or steps. In FIG. 8, this link is wired.

In this way, a reset request sequence coming from the contact interface 7 (cold or hot reset) causes an interruption towards the interruptions controller block 101 in the same way as any other peripheral.

An application whose data uses the contact interface 7 can thus use this signal to determine whether or not it is necessary to send an Answer-to-Reset (ATR) via a Universal Asynchronous Receiver/Transmitter 109 dedicated to the contact interface 7, and to which the contact pad C7 is connected.

It should be noted that, in the implementation of FIG. 8, the appropriate immediate warning means 102 and/or steps comprise another UART that is dedicated to the contactless interface 3.

Optionally, in an implementation, the means 103 also receive as input a signal coming from a functional block 106 forming a sleep controller sometimes referred to as “SLEEP CTRL”. In an implementation, logic phases also form a sleep controller, at least in part.

This block 106, connected as input to the means 103, optionally participates in selecting the voltage source.

Optionally, the functional block 106 overrides an electrical source selection attempt made via a configuration register, as described.

The selection logic is then disposed in the sleep controller block 106, which is then part of the immunity means 103.

The transition 13.17 is described below. The transitions 16.17 to the state 17, and 17.3, 17.15, and 17.16 from that state 17 are described further below.

A transition 13.17 corresponds to the case when the terminal 2 is in the standby state 13, the antenna 4 then being solicited by a contactless field to process via the appropriate interface 3.

The transition 16.17 corresponds initially to the example in which the terminal 2 is already in the dual interface operating state 16, the antenna 4 processing an application via the contactless interface 3 while the contact interface 7 is being solicited.

Then, the object 1 is ordered to limit the resources that it is consuming from the contact interface 7.

However, resources are necessary to achieve this standby field pick-up state: in particular the power and the resources (clock, input and output data, etc.) used by the interface 3 and the contactless application.

The aim here is thus to make processing using the contactless interface 3 possible even though the terminal 2 requires light sleep mode.

Currently, the following situation applies in such a case.

In a similar situation, a current object 1 would make a transition 16.13 which stops the contactless application (via 3), but in practice, such a transition (16.13) is not used.

Currently the object remains in the state 16, the limits imposed on resources (power, clock, etc.) of the terminal 1 via the contact interface 7 then being exceeded.

Therefore, in the above known case:
the Standard is not complied with, and the object 1 is incompatible;
manufacturers of terminals 2 see their resources consumed without any return on investment and taken from their terminals 2;
telecommunications operators and other service providers providing services made secure by the object 1 via the interface 7, see their pass-band, for business opportunities (advertisements, main service consumption, etc.) used up, without any return on investment, and taken from their networks; and
the holder 8 is dissatisfied because the resources tapped from his or her terminal 2 (batteries, etc.) thus reduce the time for which, in particular, the terminal (2) can operate on its battery power.

The transition 17.16 is the inverse of the transition mentioned above. In fact, the steps and/or means implemented for making this transition in the implementations of the invention are similar to those implemented for step 16.17 except that the electrical resources are then made available via the contact interface 7.

A description follows of the transitions 17.13 and 17.15. The steps and/or means implemented for achieving them in the implementations of the invention are similar to those of the inverse step 13.17.

Reference is made below to FIG. 4 which shows an embodiment of the invention in which means 103 include a circuit portion in an object 1 of the invention, which portion is connected via a pad C1 of the interface 7 to a terminal 2 to be made secure. In order to be capable of having the contactless application 10 select resources to be used (electrical power) in the event of a “ClkPause” mode being triggered, a diode 20 is provided for limiting the power consumed from the contactless interface 3 (antenna 4).

In addition, said means 103 further include an information-processing functional block 21 switching over between two power consumption modes, namely:
via the galvanic interface 7; or
via the contactless interface 3.

FIG. 5 shows another circuit portion of the means 103 in an object 1 of the invention, which is also connected to a terminal 2 to be made secure.

This other circuit portion forms immunity elements 22 for making the object 1 immune to changes (transitions to the state 17) of origin of the power.

Said immunity elements 22 include resistors 23 for absorbing surplus electrical power.

The elements 22 also have switch-over logic means 24 for selecting between two power consumption modes (via galvanic interface 7 or via contactless interface 3), as a function of values of results illustrating said consumptions and variations therein.

The elements 22 select the resources to be used, which makes it possible for a contactless application 10 to operate without consuming resources (power) coming from the contact interface 7 when said contact interface so requires, while also delivering the necessary resources to the chip 6 via a “contactless” power supply input 25.

A description follows of a “field pick-up in deep sleep” state 18. This state 18 is close to the state 17, and is shown in FIG. 6.

In this state 18, like in the state 17, the contact application is waiting for a command coming from the terminal 2, in the context of the transaction in progress.

The state 18 is a state imagined for the purposes of the invention, from the other impossible state 17.

The problem to be solved here is similar to the preceding problem, since it aims to withstand the disappearance of the clock source, causing a deep sleep state, while another application using the contactless interface has started.

Such is the case if the clock delivered by the contactless interface 3 disappears, while a transition requires the contact interface 7 to be in a deep sleep state with a clock pause.

Currently, in this case, the standards require, in particular, that the terminal 2 connected to the contact interface 7 cease to deliver the clock that would be necessary for the contactless application.

With some objects 1, it is not possible, in addition, to use an internal clock delivered by the chip 6 independently of the clock from the interfaces (3 or 7). Thus, for certain objects 1, the chip 6 always needs an external clock reference.

An object of the invention is to make it possible for a contactless application to operate, without consuming resources (e.g. clock and/or power) coming from the contact interface 7 when the standards imposed on the contact interface 7 so require.

Here, the problem is thus to mange clock interruptions (ClkPause in above tables 1A and 1B) as a function of the appearances (transition 18.17) and disappearances (transition 17.18) of said clock resource coming from the contact interface 7.

So long as clock resources coming from the contact interface 7 or coming from the contactless interface 3 are present, a current object 1 can process an application 9 or 10 without any risk of losing data.

But in the event that such clock resources disappear, and unless “internal” clock resources are available, i.e. when a change of state (Yes to No/No to Yes) of the “ClkPause” in the above tables takes place, the risks of untimely resetting are present and cause unacceptable situations (cf. above).

It should be noted that FIG. 8 shows, at 113, the usual location of such an internal clock generator 113, connected, in this example, as input to a power supply cable 114.

Currently a distinction must be made between two cases related to the structures of the objects 1 (and of the chip 6), which permit an “internal” clock to be generated or do not permit it, in the sense that the clock must systematically be delivered by a contact interface 7 or by a contactless interface 3.

Certain current objects 1 are however not concerned by this, the use of “internal” clock resources in the form of a clock signal generated by the chip 6 as a function of a simple electrical power supply is required of the object 1 whenever such resources are available.

For other objects 1 of the invention, clock control means 110 and/or equivalent logic steps make it possible to reach the state 18.

In other implementations and embodiments, these clock control means 110 (and/or logic steps) of the invention systematically use clock resources coming from the contactless interface 3 for processing a contactless application 10.

With the invention, the transition 14.19 corresponds (example of the cellphone) to the arrival of a field picked up by the antenna 4, while the object is in the “LOW POWER with ClkPause” state 14.

Here, the aim is to save the energy made available by the contact interface 7 because, currently, the chip 6 is completely awake (until state 12) for achieving dual interfacing.

A solution used by the invention (clock control means 110 and/or clock control logic steps) makes provision to force the object 1 to seek its power supply from the contactless interface 3, but to do so only in a manner such as to enable the signal coming from the antenna 4 to be received.

However, the object 1 capable of receiving the signal from the antenna 4 is otherwise kept in the low power consumption state 18 with no clock.

Going from the state 18 to the state 14 (transition 18.14), a solution of the invention (clock control means 110 and/or clock control logic means) makes provision, e.g. by wired means, to observe variations in the power delivered by the antenna 4 of the interface 3.

Such observation is a parameter and a step that are discriminating and that are warning signs of the transition 18.14. It can thus be understood that the means 103 and 110 have common points.

It should also be recalled that, during a pull-out at the contactless interface 3, the antenna 4 moving away from the coupler from which it receives the frames induces quite a progressive decrease in the voltage at the contactless interface 3. Thus, a lapse of time that is short but that is sufficient in most cases is available for avoiding malfunctioning.

In the invention, if the value measured by the means 103 or 110 is equal to or less than a threshold voltage value, a flag signal that expresses this parameter is sent to the operating system. Then the following are caused in clock control steps and/or via means 110:
putting into deep sleep mode (depending on the implementations, by wiring and/or application).

Mention is made below of the direct transition 18.15 between the via the contactless interface 3 operating state 15 and the field pick-up in deep sleep state 18.

This transition 18.15 corresponds, in the example of the cellphone terminal 2, to the case when the terminal 2 is initially deactivated, i.e. switched off, while a contactless transaction 10 is in progress.

Currently, the state 18 and thus any transaction involving it is impossible (inaccessible).

The invention thus meets a need for switching over a clock, in order to avoid being faced with the forced resetting constraint.

When an object 1 having two or more interfaces (contact interface, contactless interface, USB, etc.) serves for simultaneous use of at least two of the interfaces, another problem appears.

This problem is related to the fact that an application being executed in the object 1 is not capable of determining, in real time, which interfaces are active and in what states they are in (i.e. how many and which interfaces are delivering power supply and/or clock).

An on-board application in the object 1 is not currently capable of taking the necessary decisions as a function of the states of the interfaces 3 or 7.

Therefore, the application cannot operate correctly. For example, there is thus a risk that a pull-out might not be noticed and thus that the contactless application in progress is not interrupted correctly after a transaction that began on a contactless interface 3 that is deactivated early has been cancelled.

For example, currently, in an object having multiple interfaces, its interfaces 3 or 7, for example, can be activated or deactivated, while an on-board application in the object 1 is being executed continuously without being interrupted. Deactivation of one or more interfaces does not mean that the object 1 is OFF: the object 1 is in reality OFF only when all of the interfaces 3, 7 or others, are deactivated.

In order to solve these problems, the invention proposes means 11 and/or steps for continuously managing the applications.

The continuous management means 111 and/or steps have points in common with the means 101 and/or the steps for sustaining the contactless transaction in progress.

In FIG. 8, such is the case with the block of the means 101 that is referred to as the “interruptions controller”. It is a functional block that centralizes the interruption signals coming from a plurality of peripherals.

This block indicates the arrival of an interruption at the block 108 (CPU) by means of an interruption input point 112. The controller block also has an information/configuration register that enables the block 108 to:
know which peripheral has generated an interruption; and/or
activate and/or deactivate the interruptions generated by a given peripheral (interruption masking).

A few examples of interruption signals complying with the continuous management steps and/or generated by the means of the same name 111 are cited below:
Coming from the power supply management block 107 (PWR), an interruption signal indicates the appearance or the disappearance of a voltage source. This makes it possible for an application executed in the block 108 to know the states of the interfaces 3 and 7, at the physical level, when the signal is a signal carried by wiring.
Also coming from the block 107, an interruption signal indicates an ISO reset sequence at the contact interface.
Coming from the block 102 and especially from its UART dedicated to the contactless interface 3, an interruption signal indicates full acquisition of a contactless frame, the anti-collision sequence being performed successfully, e.g. in hard manner by the block 102 and/or as a background task.
Coming from the UART 109 dedicated to the contact interface 7, an interruption signal indicates that a sequence of bytes coming from the interface 7 is correctly acquired (whose size is determined as being equal to: 1 to “n”: i.e. the number of bytes in said sequence).

An implementation of the processor block 108 shown in FIG. 8 is described in more detail below.

The block 108 performs the data processing proper in the chip 6, and thus inside the object 1. In FIG. 8, this block receives as input, inter alia:
An electrical power supply (via voltage supply wiring 114 and ground wiring 115).
Interruption signals (via interruption wiring 119 connected to the point 112 and interconnecting the blocks 108 and 101).
The clock signal via clock input wiring 117 itself connected to a clock control block 118 described below.
Reset signals via wiring 116.
Data, via wiring 125 itself connected to the block 124.

This block 108 interchanges data with the peripherals via the bus-forming block 124 while wiring 126 connected to the block 108 provides the address inputs/outputs that make it possible to select the peripheral for which the data exchange over the data bus 124 takes place.

In addition, the block 108 (CPU) executes the contact application and/or the contactless application (9/10) proper, including successions of instructions stored in the memories of the block 120 (in FIG. 8: RAM 122; ROM 121; and EEPROM 123).

The block 108 is said to be in sleep mode when it is powered electrically but when the execution of the contact and/or contactless application (9/10) is paused (with its context backed up), thereby making it possible to consume a small amount of resources (in particular electrical resources).

Steps and/or means 103 for providing immunity from variations in power supply and including a block 107 are described above with reference to FIG. 8.

Inside the immunity means 103, the functional block 104 includes the modulator-demodulator and anti-collision processing elements. This block serves in particular for converting the radiofrequencies received by the antenna 4, in this example via the contacts C4 and C8 into:
Voltage for the block 107.
A clock signal for the block 118.
Data for the UART block 102 dedicated to the contactless interface 3.

Anti-collision steps specific to the contactless type of transmission picked up by the antenna 4 are provided here, transparently, as a background task, without disturbing operation of the processor block 108.

Mention is made above of the clock control block 118. This block 118 serves to deliver an appropriate clock signal to the block 108 (CPU) and to the peripherals requiring such a signal. The block 118 receives as input:
The clock signal available on the contact C3 (CLK).
The clock signal coming from the block 104 that includes the modulator/demodulator.
Optionally the signal from an internal clock block 113. This internal clock must be generated by means of the voltage delivered by the power supply controller block 107. In certain embodiments, such a block 113 makes implementation easier when it is useful to have a clock signal that is independent from any external time delay resource.

The clock control block 11 has a configuration/information register making it possible for the application processed by the processor block 108 to choose the physical source of the clock delivered to the block 108, or indeed to choose an automatic mode.

An ordinary implementation of the invention is as follows: the clock source is automatically selected by the block 118 so that the chip 6 is always time-delayed by a clock signal.

The invention also provides time delay means and/or steps.

Typically, the choice of the time delay source is made by wiring and/or logic phases coming from the operating system. For example, it necessary both for the contact applications and for the contactless operations to have a time-delay source, so as to indicate the activity of the object 1 to the terminal 2 (confirmation of presence).

In an implementation of the invention, the time delay source is exclusively:
internal (e.g. in the form of a phase lock loop or “PLL”) to the object 1, in particular to its chip 6;
coming from the contactless interface 3; or
coming from the contact interface 7.

FIG. 8 shows, for example, means for choosing the time delay source, which means are provided in the block 126. These means for choosing the time-delay source receive, for this purpose, wiring and/or input signals that are:
from the chip 6 and internal (e.g. coming from the block 118 or 113);
contactless and internal (coming from the means 104);
contact and external (coming from the contact pad C3).

The block 118 continuously delivers a clock signal to the chip 6 (so long as it is required, except in deep sleep mode for energy-saving reasons).

This now brings us to the block 106 sometimes referred to as “SLEEP CTRL” which manages the steps for entering and/or exiting from the sleep state.

In the implementation shown in FIG. 8, said block 106 serves to guarantee compliance with the standards imposed on the contact interface 7, which standards are telephony standards in the example of the cellphone terminal 2.

Thus, this concerns limiting electrical power consumption and withstanding the “ClkPause”.

As shown in FIG. 8, the block 106 has as input, in particular wiring coming from the interruptions controller 101 (for receiving the signal expressing the event that conditions the awakening of the processor block 108).

As output, the block 106 has, in particular:
wiring coming from the block 101 and via which the signals for awakening the processor block 108 pass;
wiring coming from the block 107 via which the electrical power sources from the chip 6 are forced, in certain implementations only.

This block 106 also has an information/configuration register that enables the application processed by the block 108 to select the event that makes it possible to wake up the block 108 (e.g. during a step in which a byte arrives in the block 109 and/or in which a frame appears via the antenna 4).

In an implementation, the invention also provides means and/or a step for selecting an operating mode in progress via the contact interface 7.

Using these means and/or step for selecting an operating mode in progress, the application determines what is the current maximum authorized consumption from the contact interface 7.

These means and/or the step for selecting an operating mode in progress choose the power supply source of the chip 6, in terms of electrical power and/or of clock. Then the means and/or the step for selecting an operating mode in progress put the chip 6 in sleep mode.

An implementation of the invention provides (state 13 or 14) a “normal” operating mode.

A transaction via the contact interface 7 only is then in progress, but the terminal 2 has not sent any command.

The chip 6 is thus in a standby phase, and, in order to satisfy the power consumption limiting constraints, the application, by using a dedicated instruction from the block 108, causes said block to go into sleep mode.

When a new command arrives (i.e. an activity is detected at the input of the block 109), the block 108 is woken up by said block 106, and the application resumes its progress.

If, while the block 108 is in sleep mode, a contactless transaction solicits the interface 3 and is initiated, the block 108 is woken up by the block 106 so as to process that transaction, without however consuming any energy or requiring a clock via the contact interface 7.

Optionally, said block 106 thus informs the block 107 that it must take its power via the block 104, and then wake up the block 108.

The other alternative is for said block 106 to wake up the block 108 first; the application then receives a signal as it wakes up, informing it that a contactless transaction has started.

The operating system then configures the block 107 itself so as to use the power received via the contactless interface 3.

A drawback with this is that power coming from the contact interface 7 continues to be consumed, for the time necessary for the operating system to switch the block 107 over to the power source coming from the contactless interface 3.

In order to mitigate this drawback, in implementations, the block 106 is configured by the application so as to comply with the limits for consumption from the contact interface 7, via a register.

In which case, it is the block 106 that reconfigures the block 107 otherwise before waking up the block 108 (CPU), thereby avoiding excessive consumption on the contact interface 7.

When the contact transaction via the interface 3 is stopped (the power received by said interface 3 is decreased to below a predetermined critical threshold), and when the transaction via the contact interface 7 is still on standby, consumption limitations require the block 108 be switched back over to sleep mode (due to insufficient power resources).

This is performed automatically here by the block 106.

In another implementation, a step makes provision for the application itself to require the block 108 to go back immediately into sleep mode.

The block 107 warns the application processed by the block 108 at a given time (due to the power delivered via the contactless interface 3 being interrupted, i.e. to the transition from “ON” to “OFF”).

A signal expressing this power supply interruption is received by the application which is adapted, in response, to sidetrack its processing and to call as quickly as possible for the instruction from the block 108 that enables it to go into sleep mode.

In such implementations, this is achieved before the voltage available by the contactless interface 3 has become insufficient.

The appropriate means 102 and/or steps for immediate warning respectively include peripherals blocks and serial switching steps.

As output, interruptions are transmitted when buffer receive memories are full, i.e. when a contactless protocol frame is received and can be processed by the chip 6.

This makes it possible for the application to perform certain processing without being disturbed by data reception.

Such interruptions notify the application that data is available for processing.

From the above, it can be understood that the pair comprising the object 1 and the terminal 2 of the invention is, in particular, by means of the standby field pick-up state 17 and by means of the deep sleep field pick-up state, capable of complying with the standards applicable in the case of operation with dual interfacing.

In particular, the problems encountered above are solved.

Thus, it is not necessary to reinitialize the chip 6, unlike the effect currently induced by obligatory activation of the resetting (RST) of the contact interface 7.

All that while also ensuring that a transaction in progress via the contactless interface continues to progress normally and that the Answer-to-Reset or “ATR” currently expected on activating the resetting (RST) of the contact interface is returned by the contact interface even thought it has not really been reinitialized.

In other words, the aim is to enable a contactless transaction in progress to be sustained throughout the start-up of the contact interface.

It should be noted, in this respect, that the “ATR” must take place within a given lapse of time, which constitutes an additional problem.

When an object 1 of the invention is powered simultaneously by two interfaces 3 and 7, if the ClkPause mode is activated, the clock source complies with the standards which currently require that the terminal 2 cease to deliver the clock necessary to the contact application 9.

This is achieved by means 19 for having the operating system select external resources.

An advantage is then to enable an application to operate without consuming resources (power and/or clock in this example) coming from the contact interface 7 when this is required.

When an object 1 is processing an application 9 for the benefit of the terminal 2, it is now possible to activate another application 10 whose data passes via the contactless interface 3.

In other words, with the invention, when the object 1 is processing a contact application, it is now possible for said object 1 to accept starting a contactless application, simultaneously.

The invention thus offers fully simultaneous management of two concurrent applications 9 and 10, and authorizes the asynchronous arrival of a contactless frame without disturbing the application in progress.

In FIG. 5, the immunity means 22 and the switch means 24 make the object 1 immune from an interruption or outage in the power supply to the object 1 via its contactless interface 3.

The advantage is to enable a contactless application 10 to operate without consuming resources (power) coming from the contact interface 7 when said contact interface so prohibits it.

With two or more interfaces (contact, contactless, USB, etc.) in an object 1, simultaneous use of at least two of such interfaces is possible with the invention.

An application being executed in the object 1 is thus able to determine which interfaces are active (i.e. how many and which of the interfaces are delivering power and clock).

In fact, an on-board application in the object 1 is able to take the necessary decisions as a function of the states of the interfaces 3 and 7.

Therefore, this application can operate correctly, e.g. when a pull-out occurs.

The following table summarizes the advantages and specificities of the invention.

TABLE 3
(situation with the invention):

| | | Transitions | |
|---|---|---|---|
| | | FIG. 6 & 7 | |
| | | From: | To: |
| | INVENTION | | |
| Transition on RF | No reset | 12 | 16 |
| with Vcc ON | No reset | 16 | 12 |
| Transition on Vcc | No reset on ISO application | 15 | 16 |
| with RF ON | Power supply & clock from ISO | 16 | 15 |
| ON/OFF ClkPause | No reset on ISO application | 17 | 18 |
| with RF ON | No reset, but initial state possible | 18 | 17 |
| Transition on RF | Chip asleep except CPU ON, power | 14 | 18 |
| With ClkPause | supply & RF clock, application | | |
| | possible | | |
| | No reset but initial state possible | 18 | 14 |
| ON/OFF Sleep | No reset on RF application, | 16 | 17 |
| with RF ON | power supply from RF, CPU ON | | |
| | No reset during transition but initial | 17 | 16 |
| | state possible | | |
| Transition on RF | Chip on ClkPause but CPU ON, | 13 | 17 |
| With sleep mode | power supply from RF, RF | | |
| | application possible | | |
| | No reset during transition but initial | 17 | 13 |
| | State possible | | |
| Transition on Vcc | No reset on ISO application | 17 | 15 |
| with RF ON & low | Power supply RF & clock from RF | 18 | 15 |
| consumption mode | | | |
| | INVENTION BEHAVIOR | | |
| Impact on circuit | Normal resetting, ditto contact chip | 16 | 16 |
| resetting | only | | |

1. A method for sustaining operation of a smart portable object provided with a processor block having at least two communications and/or power supply interfaces that are contact and/or contactless interfaces, said method including a step for reinitializing the processor block wherein said method includes at least one step for delaying and/or faking re-initialization in the event that a call/communication or an application is being processed by the processor block.

2. A method according to claim 1, wherein it includes at least one phase of detecting a reset transition capable of perceiving an interruption, e.g. in the form of an interruption processing routine.

3. A method according to claim 1, wherein it provides at least one phase of delaying the reset instructions, which phase includes at least one memory zone address, with a chosen code; the memory zone receiving instructions coming from the chosen code, execution of which generates delay commands.

4. A method according to claim 3, wherein, during the delay phase, execution of the instructions coming from the chosen code generates at least one of the following delay commands: block the contact interface in its current state, e.g. by sending a single usual Answer-to-Reset byte in response to activation of the reset; continue the application using the contactless interface; keep data useful to the contactless application in a memory without erasure; verify the ON state of the contact interface; and resume the functions required for the contact interface, e.g. by ending a series of Answer-to-Reset bytes.

5. A method according to claim 4, wherein a delay command with functions being resumed takes place after a predefined number of clock cycles, e.g. approximately in the range of 400 clock cycles to 40,000 clock cycles.

6. A method according to claim 1, wherein, during a reset transition from a via the contactless interface operating state to the dual operating state, at least one immediate warning step is provided in addition to the keep data in a memory step.

7. A method according to claim 6 wherein the immediate warning step provides a phase of switching over between the resources so that they are drawn at least in part via the contactless interface.

8. A method according to claim 6, wherein the immediate warning step provides a phase of switching over between the resources so that they are drawn at least in part via the contact interface.

9. A method according to claim 1, wherein, at the end of the warning step, interruptions are generated when a buffer receive memory is considered to be saturated, and can be processed by an operating system of the processor block, said interruptions, for example, notifying the application that data is available for processing.

10. A method according to claim 9, wherein when a contactless frame arrives, the warning step effects at least one phase of: detecting said frame, e.g. by means of the presence of a contactless electrical power supply source; transforming the frame into binary form, and initializing, for example, anti-collision processing; and, once the frame in question is considered as being correctly received and the preceding steps as being effected normally, the usual processing is authorized.

11. A method according to claim 1, wherein the other contactless standard is Standard ISO.IEC1443 relating to the contactless interface.

12. A method according to claim 1, wherein said object is suitable for communicating with at least one electronic data transmission terminal via a contact interface in compliance with Standard ISO77816.

13. A device for sustaining fully simultaneous operation of a smart portable object having a dual interface, and provided with a processor block; said object being suitable for communicating with at least one electronic data transmission terminal for electronically transmitting data via a contact interface in compliance with Standard ISO7816.3, and also in contactless manner via a contactless interface and in compliance with another, contactless standard; said device making provision as follows: the terminal is connected to the object via the contact interface so as to be made secure by the object; in the dual interface operating state, the contact interface and the contactless interface operate at the same time; the processor block including reset circuits for the purpose of reinitializing it when the contact interface is reset; said device wherein it includes at least transaction-sustaining means, including at least one element for delaying and/or faking re-initialization ordered by the contact interface during a reset transition aiming to reinitialize the processor block.

14. A device according to claim 13, wherein the transaction-sustaining means include at least one element for detecting a hot reset transition which element is capable of perceiving an interruption, said element being, for example, in the form of wiring suitable for perceiving an interruption, and for generating interruption processing.

15. A device according to claim 13 the transaction-sustaining means include at least one delay element for delaying the reset instructions, which element includes at least one memory zone address, with a chosen code; the memory zone receiving instructions coming from the chosen code, execution of which generates delay commands.

16. A device according to claim 15, wherein the delay element includes at least one delay block for delaying by at least: time-delay blocking of the contact interface; continuing the application using the contactless interface; keeping data useful to the contactless application in a memory without erasure; verifying the ON state of the contact interface; resuming the functions required for the contact interface.

17. A device according to claim 13, wherein, in addition to the transaction-sustaining means, the device includes immediate warning means.

18. A device according to claim 17, wherein the warning means include at least one element for switching over the resources to the contactless interface.

19. A device according to claim 17 wherein warning means include, at their output, at least one element with a plurality of buffer receive memories and suitable for generating interruptions if a memory is considered to be saturated.

20. A device according to claim 17, wherein the warning means include at least one contactless frame detection element.

21. A transmit terminal having at least one connection via galvanic contact to a smart portable object having a dual interface, with a contact interface enabling the object to make the terminal secure; the object being provided with a chip and being suitable for communicating with the terminal via the contact interface in compliance with Standard ISO7816.3; the object further being provided with a contactless interface communicating in compliance with another, contactless standard; wherein said terminal is suitable for taking part in implementing the method according to claim 1.

22. A terminal according to claim 21, wherein said terminal forms a cellphone and/or a handheld personal digital assistant; and/or a decoder; and/or a computer.

23. A portable smart object suitable for taking part in implementing the method according to claim 1 and/or wherein said object is a dual-interface object, and is provided with a chip; the object being suitable for communicating with at least one electronic data transmission terminal for electronically transmitting data via a contact interface in compliance with Standard ISO7816.3, and via a contactless interface and in compliance with another, contactless standard; the method making provision for: the terminal to be made secure by the object via the contact interface.

24. An object according to claim 23, wherein said object is a smart card; an electronic ticket, a “dongle”; or a module such as a proximity communications module (e.g. a Near Field Communications (NFC) module or a semi-proximity (e.g. BlueTooth) module.

25. A transmit terminal having at least one connection via galvanic contact to a smart portable object having a dual interface, with a contact interface enabling the object to make the terminal secure; the object being provided with a chip and being suitable for communicating with the terminal via the contact interface in compliance with Standard ISO7816.3; the object further being provided with a contactless interface communicating in compliance with another, contactless standard; wherein said terminal is suitable for receiving the object including the device according to claim 13.

26. A portable smart object including a device according to claim 13, wherein said object is a dual-interface object, and is provided with a chip; the object being suitable for communicating with at least one electronic data transmission terminal for electronically transmitting data via a contact interface in compliance with Standard ISO7816.3, and via a contactless interface and in compliance with another, contactless standard; the method making provision for: the terminal to be made secure by the object via the contact interface.

27. A portable smart object suitable for being connected to a terminal according to claim 21, wherein said object is a dual-interface object, and is provided with a chip; the object being suitable for communicating with at least one electronic data transmission terminal for electronically transmitting data via a contact interface in compliance with Standard ISO7816.3, and via a contactless interface and in compliance with another, contactless standard; the method making provision for: the terminal to be made secure by the object via the contact interface.
